(19) United States
(12) Patent Application Publication
(10) Pub. No.: US 2021/0206573 A1
(43) Pub. Date: Jul. 8, 2021

(54) LOAD-SUPPORTING MEANS WHICH CAN BE DRIVEN INDIVIDUALLY AND IN A DRIVERLESS MANNER AND HAS AN EJECTION REGION

(71) Applicant: Siemens Aktiengesellschaft, Muenchen (DE)

(72) Inventor: Peter ENENKEL, Konstanz (DE)

(21) Appl. No.: 17/270,558

(22) PCT Filed: Jul. 12, 2019
(86) PCT No.: PCT/EP2019/068877

§ 371 Date: Feb. 23, 2021

(30) Foreign Application Priority Data
Aug. 23, 2018 (EP) 18190511.8
Jul. 12, 2019 (EP) 19185957.8

(51) Int. Cl. B65G 1/137; B07C 5/36

(52) U.S. Cl. CPC B65G 1/1376; B65G 1/0478; B65G 1/1378; B07C 5/36

(57) ABSTRACT

A method ejects an item of piece goods from a load-supporting system which can be driven individually and in a driverless, automated manner on a surface. The method includes carrying out individual and driverless, automated transport of the goods on the load-supporting system and ejecting the item of piece goods downwards through an ejection region situated in a bottom region of the load-supporting device.

The invention relates to the technical field of load-supporting means which can be driven individually and in a driverless manner on a surface, such as can be employed, for instance, in driverless transport vehicles (DTV) which are used for sorting items of piece goods.

Continuously conveying bomb-bay cycle sorters (e.g. EUROSORT) are currently known. Continuously conveying cycle sorters nevertheless permit little flexibility and scalability.

Free-moving driverless transport vehicles (DTV) on the market are nowadays provided with the most varied of load-supporting means (LSM).

The load-supporting means is generally mounted on the top of the DTV or protruding out from the DTV to one side, such as with a forklift truck, for instance. The disadvantage of these arrangements is a very high space requirement for the DTV and the complicated support point or discharge point, since the goods must always be discharged laterally by means of sliding, tilting, rolling, or conveying, for instance. As a result, sorting or commissioning systems based on an end point matrix have an increased space requirement. This is the case, for instance, with HICKVISION matrix sorters: https://www.youtube.com/watch?v=jwu9SX3YPSk&t=2s.

Load-supporting means which project from the DTV, such as e.g. forks, moreover require significantly more space for the DTV and the LSM themselves and furthermore significant mass-balancing gears on the vehicle itself.

The object underlying the present invention is therefore to be able to eject items of piece goods from load-supporting means which can be driven individually and in a driverless manner in an efficient and space-saving manner. This object is achieved by the solutions described in the independent claims.

According to the present invention, there is provision for a method for ejecting an item of piece goods from a load-supporting means which can be driven individually and in a driverless, automated manner on a surface. The method comprises carrying out a transport journey of the item of piece goods on the load-supporting means to an ejection point and there ejecting the item of piece goods downward through an ejection region arranged in a bottom region of the load-supporting means.

The method is not restricted but particularly useful when used in sorting devices, since these often require significant and costly space.

According to the present invention, a system for ejecting an item of piece goods from a load-supporting means which can be driven individually and in a driverless, automated manner on a surface is also presented. The system comprises the load-supporting means, an ejection device, and a drive device. The load-supporting means is designed to support the item of piece goods for carrying out a transport journey. The drive device is designed to move the load-supporting means for carrying out the transport journey individually and in a driverless, automated manner.

The bottom region of the loading-supporting means comprises an ejection region, through which the item of piece goods can be ejected downward. The ejection device is designed to trigger the ejection of the item of piece goods through the ejection region.

According to the present invention, a sorting facility for items of piece goods is also presented, which comprises a plurality of such systems for ejecting an item of piece goods, and a control facility for implementing a sorting plan and for coordinating transport journeys which are to be carried out individually and in a driverless, automated manner by the load-supporting means.

Further advantageous measures are listed in the subclaims and can be combined arbitrarily with one another and be applied to both the method, the use of the method and the system in order to achieve further advantages.

According to one exemplary embodiment, the system is a DTV, which comprises the load-supporting means and the drive device. The DTV is advantageous in that it does not require any drive device which is arranged outside of the DTV, for instance on the surface upon which the load-supporting means travels. This enables investment costs to be kept to a minimum in the case of a sorting system, while a high scalability of the system is still possible by adding further DTVs.

According to one exemplary embodiment, the ejection region is arranged in a central region of the bottom region. As a result, space for further devices, such as, for instance, for electronics, a trigger mechanism for the ejection, remains in the outer regions of the bottom region. If the load-supporting means is part of a DTV, the outer region can also support a drive for moving the load-supporting means.

According to one exemplary embodiment, the item of piece goods is ejected through between chassis elements of the DTV, for instance wheels, which interact with the surface.

According to one exemplary embodiment, the ejection region of the DTV is preferably arranged between the wheels or other chassis elements.

According to one exemplary embodiment, the load-supporting means comprises a lateral wall, in order to prevent the item of piece goods from falling down laterally from the load-supporting means. This prevents the item of piece goods from falling down from the load-supporting means during the transport journey even with high acceleration and centrifugal forces.

According to one exemplary embodiment, the system is designed and adapted to stop the item of piece goods, during the transport journey and without the load-supporting means, from being ejected through the ejection region. This allows for higher dynamics. The item of piece goods can also be ejected while the load-supporting means is idling, however. This simplifies the ejection, particularly if high precision of the ejection is required.

According to one exemplary embodiment, the ejection device is designed to keep the item of piece goods resting on the ejection device during the journey. To this end, the ejection device comprises a trap door, a hatch, or a sliding door.

According to one exemplary embodiment, the ejection device comprises a trap door, a sliding door, a hatch, or a chute in order to trigger the ejection of the item of piece goods through the ejection region. According to one exemplary embodiment, the ejection region comprises an opening in a bottom structure of the load-supporting means, through which the item of piece goods can be ejected downward.

According to one exemplary embodiment, the ejection device is arranged and designed in the ejection region in order to open an ejection opening in the bottom region.

According to one exemplary embodiment, the item of piece goods is ejected through the ejection region into a further load-supporting means. In doing so the item of piece goods is preferably ejected through a cut-out in the surface, on which the load-supporting means can be driven individually and in a driverless manner, into the further load-supporting means which is arranged therebelow.

The further load-supporting means can be an end point of a sorting system, for instance, in which items of piece goods are collected according to a sorting criterion. The further load-supporting means can however also be part of a sorting intermediate layer, from which the item of piece goods is in turn ejected onto a plane positioned therebelow.

The invention is described and explained in more detail below with the aid of exemplary embodiments shown in the figures, in which:

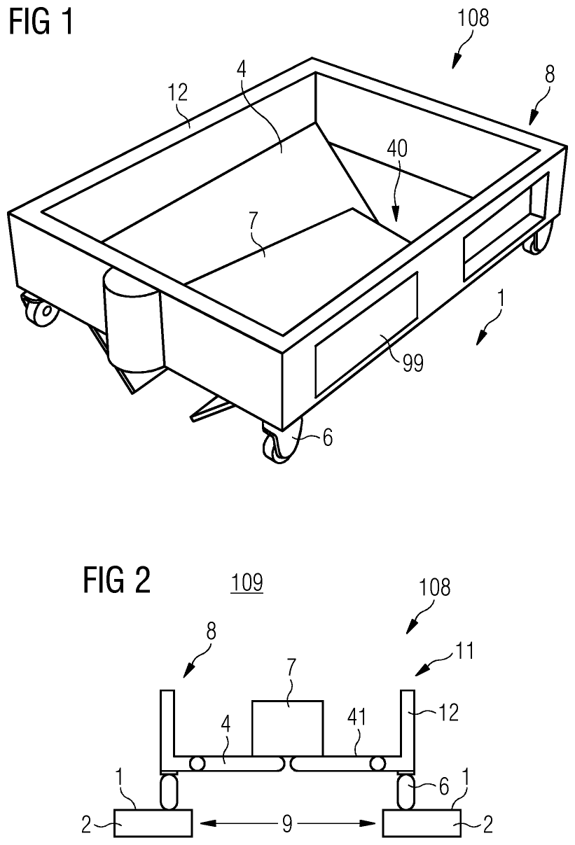

FIG. 1 shows a schematic perspective view of a system designed as a DTV for ejecting an item of piece goods from a load-supporting means which can be driven individually and in a driverless, automated manner on a surface according to an exemplary embodiment of the invention.

FIGS. 2-5 show schematic side views of the DTV shown in FIG. 1, which illustrate a method for ejecting an item of piece goods according to an exemplary embodiment in temporal succession;

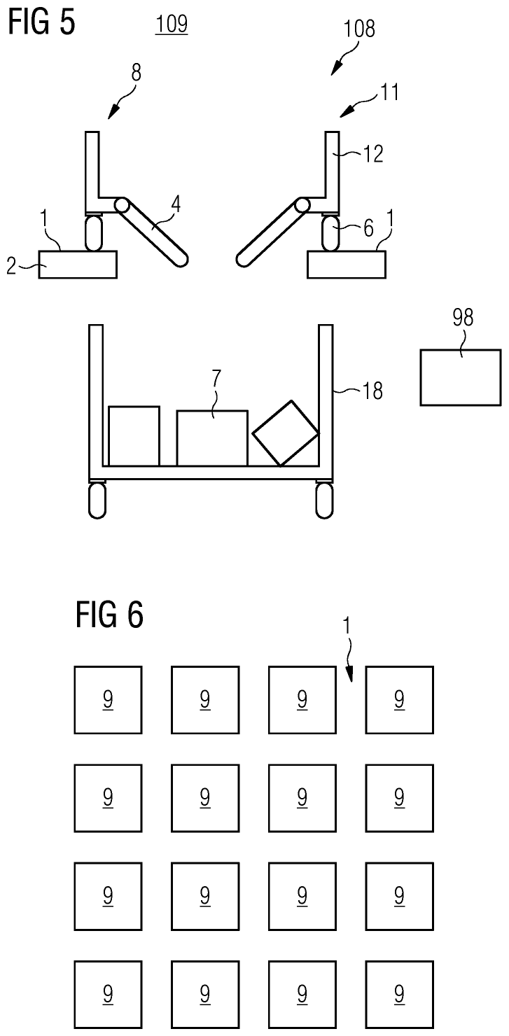

FIG. 6 shows a schematic top view onto an ejection plane of a sorting device on which DTVs, such as for instance DTVs shown in FIGS. 1-5, run individually and in a driverless manner;

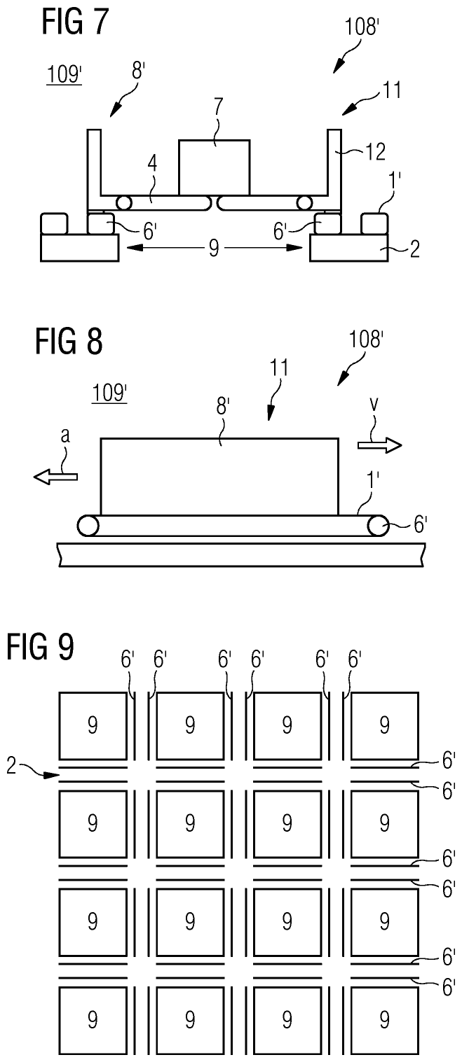

FIG. 7 shows a schematic side view of a system, which is not designed as a DTV, for ejecting an item of piece goods from a load-supporting means which can move individually and in a driverless manner on a surface according to an exemplary embodiment of the invention;

FIG. 8 shows a schematic side view of the system shown in FIG. 7 which is rotated about 90°.

FIG. 9 shows a schematic top view onto an ejection plane of the system shown in FIGS. 7 and 8.

FIG. 1 shows a system 108 designed as a DTV 108 for ejecting an item of piece goods 7 from a load-supporting means 8 which can be driven individually and in a driverless, automated manner on a surface 1 according to an exemplary embodiment of the invention.

The DTV 108 comprises the load-supporting means 8, a drive device 6 and an ejection device 4. The load-supporting means 8 comprises a frame 12 which is simultaneously a lateral wall 12 of the load-supporting means 8. In a central region, which is surrounded by the wall, the automatic ejection device 4 is arranged in a bottom region 41. The ejection device 4 comprises a hatch 4 configured as a trap door. In the closed state, the item of piece goods 7 to be transported or sorted rests on the trap door and can thus be transported to a desired ejection point by means of the DTV 108. The load-supporting means 8 or the ejection device is therefore designed to support the item of piece goods 7 for carrying out a transport journey.

If the item of piece goods 7 is to be ejected, the trap door 4 is opened automatically and the item of piece goods falls through the ejection shaft formed by the opened trap door. In this way the ejection device 4 is designed to effect an ejection of the item of piece goods 7 through the ejection region 40 defined by the trap door.

The DTV moreover comprises wheels designed as drive devices 6, wherein at least some of the wheels comprise integrated wheel drives. Within the frame 12, a control facility 99 is moreover integrated for automatically controlling the drive devices 6 of the DTV 108 and for automatically controlling the ejection device 4 and an electric energy storage unit.

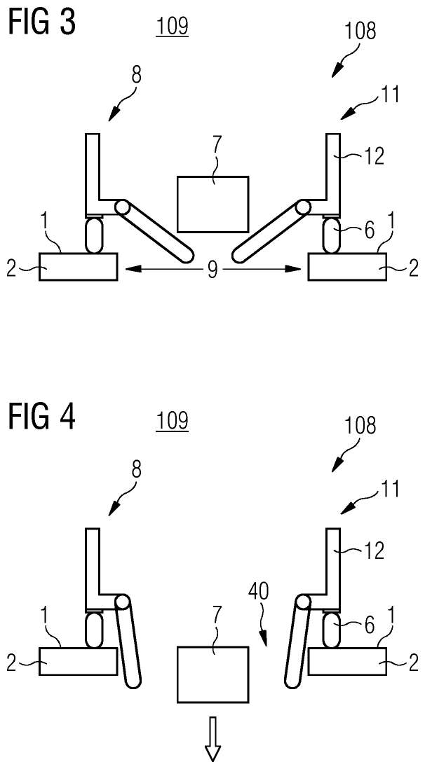

FIGS. 2-3 show schematic side views of the DTV 108 shown in FIG. 1, which illustrate a method for ejecting the item of piece goods 7 according to an exemplary embodiment in temporal succession.

FIG. 6 shows a schematic top view onto an ejection plane of a sorting device on which driverless transport vehicles, such as DTVs shown in FIGS. 1-5, for instance, run individually and in a driverless manner. The ejection plane is the upper surface 1 of a mesh-type support structure 2 arranged horizontally. Ejection points 9 designed as cut-outs are arranged in the manner of a grid sorter between the supports of the support structure 2, under which further load-supporting means 18 (see FIG. 5) can be arranged.

FIG. 2 shows the load-supporting means 8 with a closed ejection device 4 which runs on the surface 1. The item of piece goods 7 is disposed on the ejection device 4. The reference character 109 represents the system which comprises the DTV 108 and the support structure 2 with the surface 1. FIG. 2 shows the method step in which an individual, driverless and automated transport journey of the item of piece goods 7 is carried out on the load-supporting means 8 to one of the provided ejection points 9. FIGS. 3-5 show the ejection of the item of piece goods after the load-supporting means has arrived at the provided ejection point 9.

FIG. 3 shows the system 108 at a point in time at which the trap door 4 is opened.

FIG. 4 shows the system 108 at a point in time at which the trap door 4 is opened to such a degree that the item of piece goods 7 drops down through the ejection region 40 and the provided ejection point 9, in other words is ejected. The item of piece goods is 7 ejected through between the chassis elements of the DTV which are designed as wheels 6.

FIG. 5 shows the system 108 at a point in time after the item of piece goods 7 has been ejected. FIG. 5 moreover shows a further load-supporting means 18, in which the item of piece goods 7 has been ejected, arranged below the load-supporting means and below the provided ejection point 9. In the exemplary embodiment shown in FIG. 5, the further load-supporting means 18 is a sorting end point in which sorted items of piece goods 7, for instance for delivery to a specific postal code area, are collected.

FIG. 5 also shows a control facility 98, for implementing a sorting plan and coordinating transport journeys to be carried out by the load-supporting means (8). The control facility is connected communicatively with the DTV 108, preferably with a number of DTVs 108 running on the surface 1, and controls their transport journeys and ejection processes.

FIG. 7 shows a schematic side view of systems 108′, 109′ not based on DTVs for ejecting an item of piece goods 7 from a load-supporting means 8′ which can be driven individually and in a driverless manner on a surface according to a further exemplary embodiment of the invention.

FIG. 8 shows a schematic side view of the systems 108′, 109′ shown in FIG. 7 and rotated about 90°.

The load-supporting means 8′ comprises, like the load-supporting means 8, a side wall 12 and an ejection device 4, but not a separate drive device 6. Instead, a drive device 6′ is installed on the supports of the mesh structure 2. FIG. 9 shows a schematic top view onto the mesh structure 2 of the systems 108′, 109′ shown in FIGS. 7 and 8.

Contrary to the systems 108, 109, the systems 108′, 109′ are not or therefore do not comprise driverless transport vehicles with a separate drive device, but instead drives are mounted in pairs on the upper surface of the mesh structure 2 in the form of belt conveyors 6′. By way of example, the drive device 6′ in the form of belt conveyors 6′ on the mesh structure 2 can be mounted in pairs on both sides of an ejection point 9, as shown in FIG. 9, so that the load-supporting means 8′ is conveyed on or over the respective ejection point by two belt conveyors 6′ synchronised on opposite sides of the ejection point 9. The drive device 6′ is designed to convey the load-supporting means 8′ optionally in one of the two directions defined orthogonally to one another by the mesh structure 2. In this way, a load-supporting means 8′ with an ejection device 4 can be conveyed resting directly on the belt conveyors 6′ to an ejection point 9, and an item of piece goods 7 resting on the ejection device 4 can be ejected through the trap door of the ejection device 4 into a load-supporting means lying therebelow.

As in the exemplary embodiments shown on the basis of FIGS. 1-6, the transport journey for the load-supporting means 8′ can also be carried out individually with the exemplary embodiments shown on the basis of FIGS. 7-9. Aside from the load-supporting means 8′ with the ejection device 4, the system 108′ also comprises the drive device 6′. The system 109′ comprises the system 108′ and moreover the supporting structure 2 and/or further load-supporting means 8′, 18.

With the concepts shown in this disclosure, more comprehensive sorting devices can also be realised according to further exemplary embodiments, for instance by a plurality of load-supporting means 8, 8′ running on the surface 1, 1′ of an ejection plane, which transport the items of piece goods to the respectively provided ejection points 9 and there in each case through an ejection region arranged in a bottom region of the load-supporting means and through the respective ejection point into end points or other load-supporting means.

According to further exemplary embodiments, the space requirement for the travel paths, the load-supporting means and the necessary surfaces for the end points is reduced by discharging the goods through the load-supporting means or DTV (bomb-bay).

According to a further exemplary embodiment, the for ejecting an item of piece goods 7 comprises a tub-shaped DTV, in which the drive and energy storage technology is only installed at the edge of the DTV. The goods can be discharged downward directly below the DTV through a chute, a sliding door, or a trap door in the bottom, for instance.

By bearing the item of piece goods 7 in the interior of the DTV, on account of the deep and central position of central gravity this can be designed in a very lightweight manner without the balancing weights otherwise required in forklift trucks. This results in a very light and thus very energy-efficient DTV or other load-supporting means.

According to one exemplary embodiment, the item of piece goods is output downward through the DTV in the negative Z-direction.

According to further exemplary embodiments, during the journey or when idling the item of goods is ejected in the negative Z-direction (downward) between the chassis elements through the free-running load-supporting means or DTV, for instance into end points. The end points here can be depressions (pits) or the load-supporting means or DTV is assembled to be correspondingly long-legged.

Conversely, the items of piece goods can be received into the load-supporting means from all other directions at loading points and also directly from below.

1-15. (canceled)

16. A method for ejecting an item of piece goods from a load-supporting system which can be driven individually and in a driverless, automated manner on a surface, which comprises the method steps of:
carrying out an individual, driverless and automated transport journey of the item of piece goods on the load-supporting system; and
ejecting the item of piece goods downward through an ejection region disposed in a bottom region of the load-supporting system.

17. The method according to claim 16, wherein the load-supporting system is included in a driverless transport vehicle (DVT) which carries out the transport journey.

18. The method according to claim 17, wherein the ejection region is disposed in a central region of the bottom region and/or wherein the item of piece goods is ejected through between chassis elements of the DTV.

19. The method according to claim 16, wherein the load-supporting system has a lateral wall.

20. The method according to claim 16, wherein during the transport journey and without stopping the load-supporting system the item of piece goods is ejected through the ejection region.

21. The method according to claim 16, wherein the load-supporting system contains an ejection device configured to trigger the ejection of the item of piece goods through the ejection region.

22. The method according to claim 16, wherein the item of piece goods is ejected through the ejection region into a further load-supporting system.

23. The method according to claim 21, wherein the ejection device is a trap door, a sliding door, a hatch or a chute creating an ejection opening, wherein the ejection device is configured to keep the item of piece goods resting on the ejection device during the transport journey.

24. A method of operating a sorting device, which comprises the steps of:
providing a load-supporting system being driven individually and in a driverless, automated manner on a surface;
carrying out an individual, driverless and automated transport journey of an item of piece goods on the load-supporting system; and
ejecting the item of piece goods downward through an ejection region disposed in a bottom region of the load-supporting system.

25. A system for ejecting an item of piece goods, the system comprising:
a load-supporting system being driven in a driverless, automated manner on a surface;
an ejection device;
a drive device;
said load-supporting system configured to receive the item of piece goods for carrying out a transport journey;
said drive device configured to drive said load-supporting system for carrying out the transport journey individually and in a driverless, automated manner;
said load-supporting system having a bottom region with an ejection region, through which the item of piece goods can be ejected downward; and
said ejection device is configured to trigger an ejection of the item of piece goods through said ejection region.

26. The system according to claim 25, wherein the system is a driverless transport vehicle (DVT).

27. The system according to claim 26,
further comprising chassis elements;
wherein said ejection region is disposed in a central region of said bottom region and/or in said load-supporting system so that the item of piece goods can be ejected through between said chassis elements of said DTV and/or said ejection device is configured in order to generate an ejection opening and/or to support the item of piece goods resting on said ejection device during the transport journey.

28. The system according to claim 25, wherein said load-supporting system has a lateral wall.

29. The system according to claim 25, wherein the system is configured and adapted to eject the item of piece goods through said ejection region during the transport journey and without stopping said load supporting system.

30. The system according to claim 25, further comprising a further load-supporting system, in which the item of piece goods can be ejected through said ejection region of said load-supporting system.

31. The system according to claim 27, wherein said chassis elements are wheels.

32. A sorting device for items of piece goods, the sorting device comprising:
a plurality of systems for ejecting the item of piece goods, the systems each being configured according to claim 25; and
a control facility for implementing a sorting plan and coordinating transport journeys to be carried out by said load-supporting systems.
